(19) United States
(12) Patent Application Publication
(10) Pub. No.: US 2023/0138145 A1
(43) Pub. Date: May 4, 2023

(54) INFORMATION PROCESSING DEVICE, VEHICLE, INFORMATION PROCESSING METHOD, AND STORAGE MEDIUM

(71) Applicant: TOYOTA JIDOSHA KABUSHIKI KAISHA, Toyota-shi (JP)

(72) Inventor: Taiki MIZUTANI, Nisshin-shi (JP)

(21) Appl. No.: 18/050,149

(22) Filed: Oct. 27, 2022

(30) Foreign Application Priority Data
Nov. 4, 2021 (JP) 2021-180653

(51) Int. Cl. G06F 9/455

(52) U.S. Cl. CPC G06F 9/45558; G06F 2009/4557; G06F 2009/45583

(57) ABSTRACT

An information processing device includes: a memory; and a processor coupled to the memory, the processor being configured to generate plural virtual machines including a management virtual machine that manages the plural virtual machines, detect predetermined plural phases, and set resource allocation times for the plural virtual machines to predetermined schedules for each of the plural phases based on the detection result.

### CROSS-REFERENCE TO RELATED APPLICATION

This application is based on and claims priority under 35 USC 119 from Japanese Patent Application No. 2021-180653 filed on Nov. 4, 2021, the disclosure of which is incorporated by reference herein.

### BACKGROUND

### Technical Field

The present disclosure relates to an information processing device that is applicable to a vehicle system, a vehicle, an information processing method, and a non-transitory storage medium storing an information processing program.

### Related Art

Japanese Patent Application Laid-open (JP-A) No. 2016-091109 proposes a dynamic resource allocation apparatus that calculates resource allocation amounts to allocate to a virtual machine and dynamically allocates the resources. Specifically, the resource allocation apparatus includes: a usage amount calculator that calculates a fixed usage amount, which is a resource usage amount actually used for each time slot divided as a division of a resource fluctuation period of a virtual machine; a spike detector that detects a spike of the fixed usage amount; an allocation amount calculator that calculates a resource allocation amount to be allocated to the i-th time slot based on the past fixed usage amount in the i-th time slot and a detection result of a past spike in a time slot included in a predetermined range before and after the i-th time slot; and an allocation amount setter that sets the allocation amount to a virtual machine monitor, which controls the virtual machine.

In systems where real time responsiveness must be guaranteed, such as in-vehicle systems, it becomes difficult to verify the feasibility of the system when resource allocation times are dynamically adjusted, so there is room for improvement.

### SUMMARY

The present disclosure has been devised in consideration of the above circumstances and provides an information processing device, a vehicle, an information processing method, and a non-transitory storage medium storing an information processing program that may adjust resource allocation times and may be applied to a system where real time responsiveness is needed.

A first aspect of the disclosure is an information processing device including: a creation unit that creates plural virtual machines including a management virtual machine that manages the plural virtual machines; a detection unit that detects predetermined plural phases; and a setting unit that sets resource allocation times for the plural virtual machines to predetermined schedules for each of the phases based on the result of the detection by the detection unit.

According to the first aspect, in the creation unit, the plural virtual machines including the management virtual machine that manages the plural virtual machines are created.

In the detection unit, the predetermined plural phases are detected, and in the setting unit, the resource allocation times for the plural virtual machines are set to predetermined schedules for each of the phases based on the result of the detection by the detection result. Because of this, the resource allocation times may be changed by phase. Furthermore, in each phase, since the CPU allocation times are fixed and scheduling is static, real time responsiveness needed in an in-vehicle system may be guaranteed. Consequently, an information processing device that is able to adjust resource allocation times and may be applied to a system where real time responsiveness is needed may be provided.

The plural phases may include a startup phase, and when the startup phase is detected by the detection unit, the setting unit may set the allocation time only to the management virtual machine or set the allocation time for the management virtual machine to a longer time than the allocation times for the other virtual machines. Because of this, the management virtual machine that has functions such as initializing needed for each of the virtual machines to run may be quickly started up.

Furthermore, the plural phases may include a normal phase, and when the normal phase is detected by the detection unit, the setting unit may set the allocation times for the plural virtual machines to predetermined normal times. Because of this, allocation times needed in normal running may be allocated to each of the virtual machines.

Furthermore, the plural phases may include a sleep phase, and when the sleep phase is detected by the detection unit, the setting unit may set the allocation time for the management virtual machine to a longer time than the allocation times for the other virtual machines. Because of this, the time to move to the sleep phase and the time to wake up from the sleep phase may be shortened.

A second aspect of the disclosure is a vehicle equipped with an information processing device according to the first aspect.

A third aspect of the disclosure is an information processing method including: generating plural virtual machines including a management virtual machine that manages the plural virtual machines, detecting predetermined plural phases, and setting resource allocation times for the plural virtual machines to predetermined schedules for each of the phases based on the detection result.

A fourth aspect of the disclosure is a non-transitory storage medium storing a program that causes a computer to execute information processing, the information processing including: generating plural virtual machines including a management virtual machine that manages the plural virtual machines, detecting predetermined plural phases, and setting resource allocation times for the plural virtual machines to predetermined schedules for each of the phases based on the detection result.

As described above, according to the present disclosure, there can be provided an information processing device, a vehicle, an information processing method, and a non-transitory storage medium storing an information processing program, which may adjust resource allocation times and can be applied to a system where real time responsiveness is necessary.

### BRIEF DESCRIPTION OF THE DRAWINGS

FIG. 1 is a diagram illustrating a vehicle equipped with a central ECU pertaining to an embodiment of the disclosure;

FIG. 2 is a block diagram illustrating the schematic configuration of the central ECU pertaining to the embodiment;

FIG. 3 is a functional block diagram illustrating functions of a hypervisor;

FIG. 4 is a diagram illustrating an example of the scheduling of CPU allocation times by phase; and

FIG. 5 is a flowchart illustrating an example of a flow of processes when setting the CPU allocation times performed by the central ECU pertaining to the embodiment.

### DETAILED DESCRIPTION

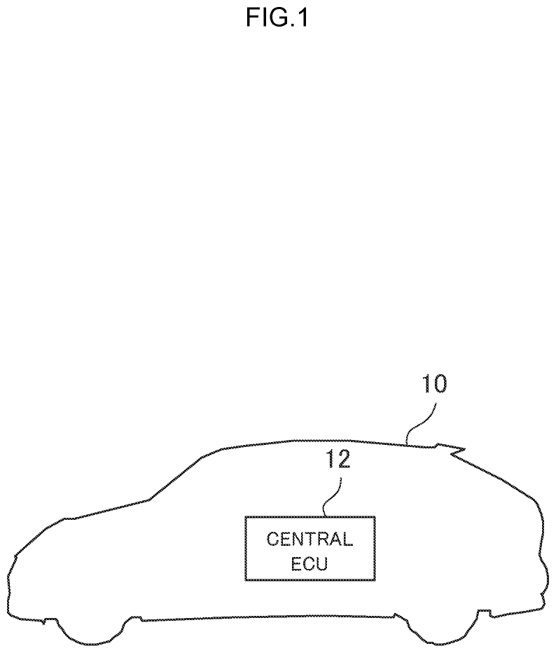

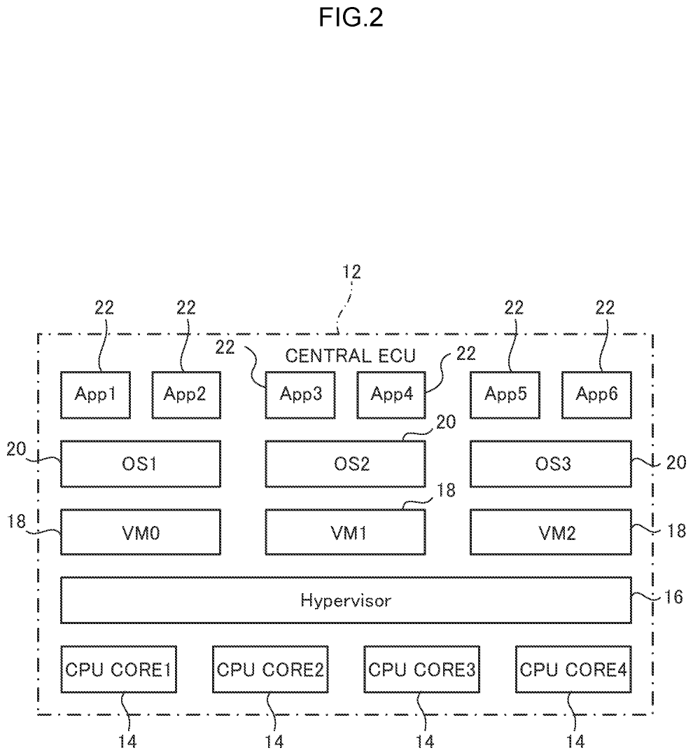

An example of an embodiment of the disclosure will be described in detail below with reference to the drawings. In this embodiment, a central electronic control unit (ECU) 12 installed in a vehicle 10 will be described as an example of the information processing device. In the embodiment, FIG. 1 is a diagram illustrating the vehicle 10 equipped with the central ECU 12 pertaining to this embodiment and FIG. 2 is a block diagram illustrating the schematic configuration of the central ECU 12 pertaining to this embodiment.

The central ECU 12 pertaining to this embodiment is installed in the vehicle 10 and centrally controls various types of ECUs provided in the vehicle 10.

The central ECU 12 is provided with a memory (not illustrated in the drawings) including a nonvolatile memory and a central processing unit (CPU). In the embodiment, as an example, as illustrated in FIG. 2, the central ECU 12 has plural CPU cores 14 (in the example of FIG. 2, four CPU cores, a CPU core1 to a CPU core4).

In the embodiment, physical CPU cores 14 are virtualized and virtual machines (VMs) 18 are created by a hypervisor 16 that is software for virtualizing a computer. In the embodiment, plural VMs 18 are created by the hypervisor 16. FIG. 2 illustrates an example where three VMs 18, a VM0 to a VM2, are created as the plural VMs 18.

Each of the VMs 18 has an operating system (OS) 20, and applications (apps) 22 run on the OSs 20. In FIG. 2, an app1 and an app2 run on an OS1, an app3 and an app4 run on an OS2, and an app5 and an app6 run on an OS3.

In a typical hypervisor, the hypervisor itself has the function of managing each of the VMs. However, in the hypervisor 16 for an in-vehicle system as in this embodiment, the functions of the hypervisor 16 are reduced as much as possible to guarantee real time responsiveness, and one of the VMs 18 has the function of managing each of the VMs 18. In the embodiment, the VM0 functions as a management virtual machine that manages each of the VMs 18. Below, the VM0 may be also referred to as “the overall management VM 18.” Furthermore, in a case in which the overall management VM 18 is provided, the coupling between the overall management VM 18 and each of the VMs 18 increases, so that they have a dependent relationship.

Furthermore, because the hypervisor 16 has the plural VMs 18, each of the VMs 18 may look like they are running in parallel by allocating CPU times to each of the VMs 18.

In order to efficiently run each of the VMs 18, it is desirable to dynamically change the scheduling of the CPU allocation times as resources. However, in an in-vehicle system, when the scheduling is dynamically changed, it becomes difficult to guarantee real time responsiveness.

Therefore, in the central ECU 12 pertaining to the embodiment, the CPU allocation times are semi-dynamically scheduled by changing the scheduling of the CPU allocation times by phase. Because of this, scheduling appropriate to each phase may be applied. Furthermore, real time responsiveness can be guaranteed because scheduling is static when seen in phase units.

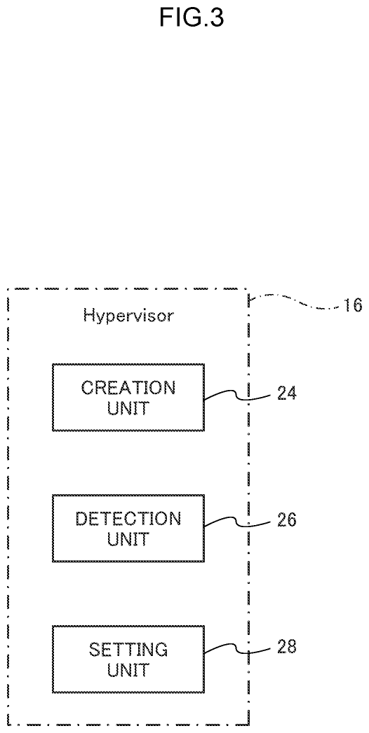

Here, functional configurations of the hypervisor 16 for changing the scheduling of the CPU allocation times by phase will be described. FIG. 3 is a functional block diagram illustrating functions of the hypervisor 16.

As illustrated in FIG. 3, the hypervisor 16 has functions of a creation unit 24, a detection unit 26, and a setting unit 28.

The creation unit 24 creates and executes the plural VMs 18 in which the physical CPU cores 14 are virtualized. In the embodiment, as described above, the creation unit 24 creates three VMs 18, i.e., the VM0 to the VM2.

The detection unit 26 detects plural phases for changing the CPU allocation times. In the embodiment, the detection unit 26 detects three phases, i.e., a startup phase, a normal phase, and a sleep phase.

The setting unit 28 changes the CPU allocation times to predetermined schedules by phase based on the result of the detection by the detection unit 26 and sets the scheduling of the CPU allocation times. In the embodiment, the setting unit 28 changes the scheduling of the CPU allocation times by phase in regard to each of the startup phase, the normal phase, and the sleep phase.

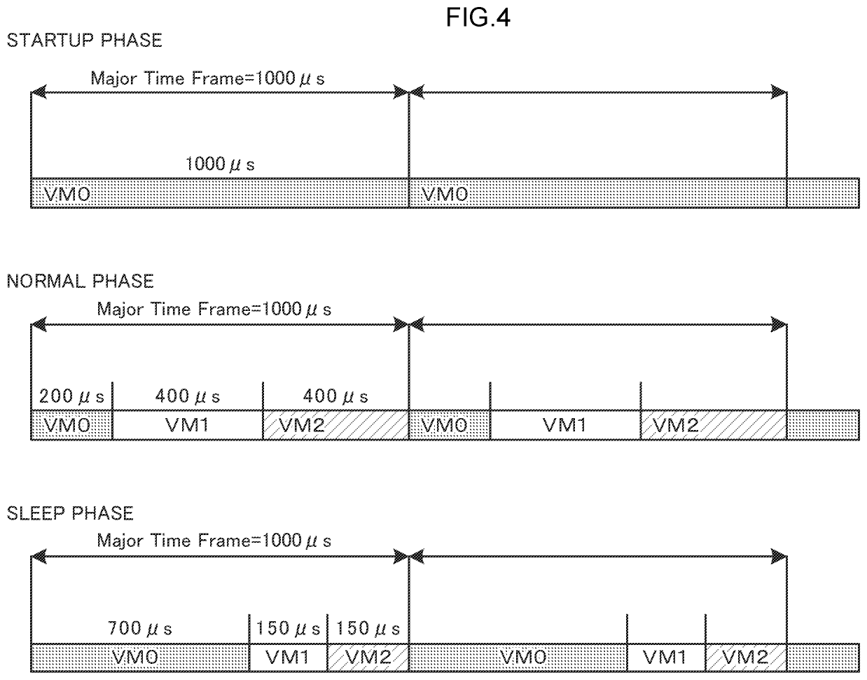

FIG. 4 is a diagram illustrating an example of the scheduling of the CPU allocation times by phase. FIG. 4 illustrates an example of the scheduling of the CPU allocation times in the startup phase, the normal phase, and the sleep phase. In each phase, the major time frame is 1000 μs.

In the startup phase, in order to quickly start up the overall management VM 18 (i.e., the VM0 in FIG. 2) that has functions such as initialization needed for each of the VMs 18 to run, the VM0 occupies the CPU time. Namely, in the startup phase in FIG. 4, the VM0 is allocated 1000 μs and the VM1 and the VM2 are allocated 0 μs, and after the overall management VM 18 is initialized, the phase moves to the normal phase. It will be noted that although FIG. 4 illustrates an example where the VM0 occupies the CPU time, the disclosure is not limited to this, and the CPU time allocated to the VM0 may also be set to a longer time than the CPU times allocated to the VM1 and the VM2.

In the normal phase, the setting unit 24 sets, as predetermined normal times, CPU allocation times needed for each of the VMs 18 to run normally. FIG. 4 illustrates an example where the VM0 is allocated 200 μs and the VM1 and the VM2 are each allocated 400 μs.

In the sleep phase, data storage requests concentrate on the VM0, which is the overall management VM 18 that collectively manages the nonvolatile memory, so the setting unit 28 increases the CPU time allocated to the overall management VM 18 and shortens sleep time. FIG. 4 illustrates an example where the VM0 is allocated 700 μs and the VM1 and the VM2 are each allocated 150 μs.

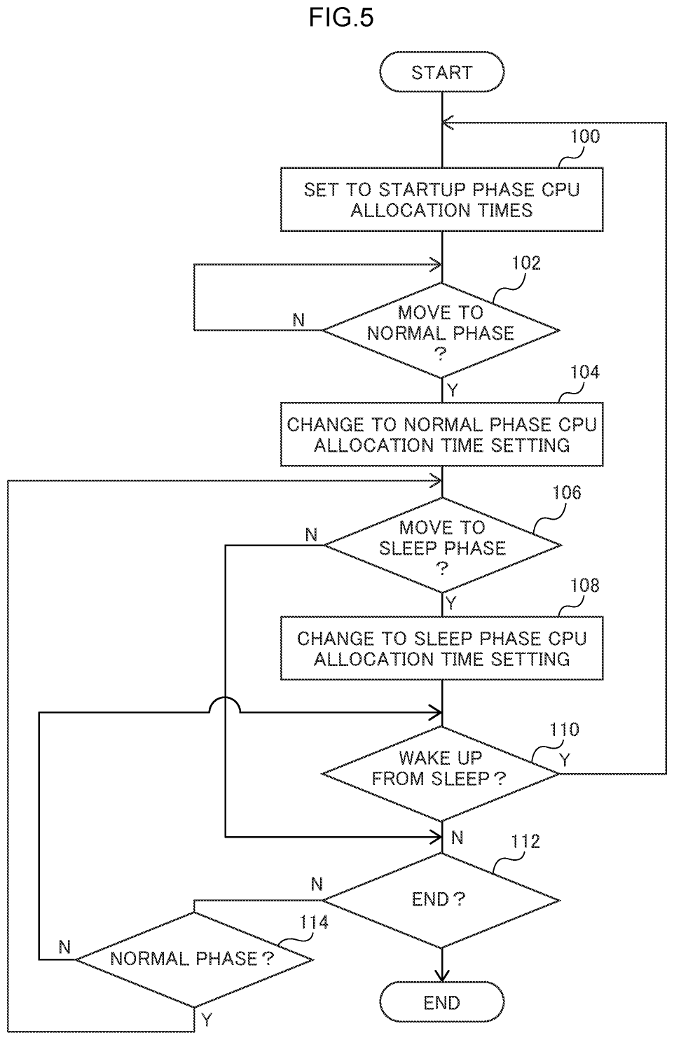

Next, specific processes performed by the central ECU 12 pertaining to the embodiment configured as described above will be described. FIG. 5 is a flowchart illustrating an example of a flow of processes when performing setting of the CPU allocation times performed by the central ECU 12 pertaining to this embodiment. It will be noted that the processes in FIG. 5 start after, for example, the vehicle's power supply, such as an ignition switch not illustrated in the drawings, is switched on.

In step 100 the hypervisor 16 sets the CPU allocation times to the startup phase CPU allocation times, and then the hypervisor 16 moves to step 102. Namely, after the vehicle's power supply is switched on, the detection unit 26 detects the startup phase and the setting unit 28 sets the CPU allocation times to the startup phase CPU allocation times. Specifically, as illustrated in FIG. 4, the VM0, which is the overall management VM 18, is allocated 1000 μs and the VM1 and the VM2 are allocated 0 μs, so that the VM0, which is the overall management VM 18, occupies the CPU time.

In step 102 the hypervisor 16 determines whether or not to move to the normal phase. This determination is, for example, performed by the detection unit 26 determining whether or not it has received a notification to end the startup phase from the overall management VM 18. The hypervisor stands by until the determination becomes YES and then moves to step 104.

In step 104 the hypervisor 16 changes the CPU allocation times to the normal phase CPU allocation times, and then the hypervisor 16 moves to step 106. Namely, the setting unit 28 changes the CPU allocation times to the normal phase CPU allocation time setting. Specifically, as illustrated in FIG. 4, the setting unit 28 changes the CPU allocation times so that the VM0 is allocated 200 μs and the VM1 and the VM2 are each allocated 400 μs.

In step 106 the hypervisor 16 determines whether or not to move to the sleep phase. This determination is, for example, performed by the detection unit 26 determining whether or not it has detected that a predetermined condition for moving to the sleep phase has been met. When the determination is YES, the hypervisor 16 moves to step 108, and when the determination is NO, the hypervisor 16 moves to step 112.

In step 108 the hypervisor 16 changes the CPU allocation times to the sleep phase CPU allocation time setting, and then the hypervisor 16 moves to step 110. Namely, the setting unit 28 changes the CPU allocation times to the sleep phase CPU allocation time setting. Specifically, as illustrated in FIG. 4, the VM0, which is the overall management VM 18, is allocated 700 μs and the VM1 and the VM2 are each allocated 150 μs, thereby increasing the CPU time allocated to the overall management VM 18 and shortening the time to transition to sleep and wake up.

In step 110 the hypervisor 16 determines whether or not to wake up from sleep. This determination is, for example, performed by the detection unit 26 determining whether or not it has detected that a predetermined condition for waking up from sleep has been met. In a case in which the determination is YES, the hypervisor 16 returns to step 100 and repeats the above processes, and in a case in which the determination is NO, the hypervisor 16 moves to step 112. It will be noted that although the embodiment describes an example where the hypervisor 16 returns to step 100 and moves to the startup phase after waking up from the sleep phase, the disclosure is not limited to this, and the hypervisor 16 may also move to the normal phase after waking up from the sleep phase. In this case, if the determination of step 110 is YES, the hypervisor 16 moves to step 104.

In step 112 the hypervisor 16 determines whether or not to end the processes. This determination is, for example, performed by the detection unit 26 determining whether or not it has detected that the vehicle's power supply, such as the ignition switch not illustrated in the drawings, has been switched off. In a case in which the determination is NO, the hypervisor 16 moves to step 114, and in a case in which the determination is YES, the hypervisor 16 ends the series of processes.

In step 114 the hypervisor 16 determines whether or not it is in the normal phase. In this determination, the hypervisor 16 determines whether or not it is in the normal phase, and in a case in which it is in the normal phase, the determination is YES and the hypervisor 16 returns to step 106 and repeats the above processes. In a case in which it is in the sleep phase, the determination is NO and the hypervisor 16 returns to step 110 and repeats the above processes.

By performing the processes in this way, the scheduling of the CPU times allocated to each of the VMs 18 may be changed by phase, and the resource allocation times can be adjusted.

Furthermore, in each phase, the CPU allocation times are fixed and the scheduling is static, so real time responsiveness needed by an in-vehicle system may be guaranteed.

It will be noted that although the above embodiment described an example where the central ECU 12 includes four CPU cores 14, embodiments are not limited to this. For example, the central ECU 12 may be configured to include one CPU core 14 or configured to include plural CPU cores other than four.

Furthermore, although the above embodiment described an example where the hypervisor 16 creates three VMs 18, embodiments are not limited to this. For example, the hypervisor 16 may create two VMs 18 or create four or more VMs 18.

Furthermore, although the above embodiment described three phases, i.e., the startup phase, the normal phase, and the sleep phase, as an example of the phases, the phases are not limited to these three phases. For example, the phases may be other different plural phases besides these three phases, or may be two phases out of these three phases, or may be plural phases to which other phases have been added to these three phases.

Furthermore, the processes performed by the hypervisor 16 in the above embodiment may also be stored as a program in various types of storage media and circulated.

Moreover, it is to be understood that the present disclosure is not limited to the above embodiment and may be implemented with various modifications made thereto without departing from the spirit thereof.

What is claimed is:

1. An information processing device comprising:
a memory; and
a processor coupled to the memory, the processor being configured to
generate a plurality of virtual machines including a management virtual machine that manages the plurality of virtual machines,
detect a predetermined plurality of phases, and
set resource allocation times for the plurality of virtual machines to predetermined schedules for each of the plurality of phases based on the detection result.

2. The information processing device of claim 1, wherein
the plurality of phases include a startup phase, and
in a case in which the startup phase is detected, the processor sets the allocation time only to the management virtual machine or sets the allocation time for the management virtual machine to a longer time than the allocation times for the other virtual machines.

3. The information processing device of claim 1, wherein
the plurality of phases include a normal phase, and
in a case in which the normal phase is detected, the processor sets the allocation times for the plurality of virtual machines to predetermined normal times.

4. The information processing device of claim 1, wherein
the plurality of phases include a sleep phase, and
in a case in which the sleep phase is detected, the processor sets the allocation time for the management virtual machine to a longer time than the allocation times for the other virtual machines.

5. A vehicle equipped with the information processing device of claim 1.

6. An information processing method comprising:
generating a plurality of virtual machines including a management virtual machine that manages the plurality of virtual machines,
detecting a predetermined plurality of phases, and
setting resource allocation times for the plurality of virtual machines to predetermined schedules for each of the plurality of phases based on the detection result.

7. A non-transitory storage medium storing a program that causes a computer to execute information processing, the information processing comprising:
generating a plurality of virtual machines including a management virtual machine that manages the plurality of virtual machines,
detecting a predetermined plurality of phases, and
setting resource allocation times for the plurality of virtual machines to predetermined schedules for each of the plurality of phases based on the detection result.
